(19) United States
(12) Patent Application Publication
(10) Pub. No.: US 2001/0056444 A1
(43) Pub. Date: Dec. 27, 2001

(54) Communication terminal device

(76) Inventors: Motoki Ide, Tokyo (JP); Naoya Shibata, Fukuoka (JP)

Correspondence Address: OSTROLENK FABER GERB & SOFFEN, 1180 AVENUE OF THE AMERICAS, NEW YORK, NY, 100368403

(21) Appl. No.: 09/827,476

(22) Filed: Apr. 6, 2001

(30) Foreign Application Priority Data
Apr. 7, 2000 (JP) 2000-106834

(51) Int. Cl. G06F 17/21; G06F 17/30; G06F 15/16

(52) U.S. Cl. 707/513; 707/501.1; 707/526; 709/219; 709/246; 707/10

(57) ABSTRACT

A communication terminal device that can achieve browsing contents described in different information description languages without installing corresponding browsers. A content obtainer obtains content data from a desired content server via a network. A content-type discriminator discriminates a content type of the obtained content data from a plurality of predetermined content types. A plurality of parsers corresponding to respective ones of the plurality of predetermined content types are provided and the obtained content data is parsed by a corresponding parser depending on the discriminated content type thereof to produce displaying information. Based on the displaying information, an obtained content is displayed.

### BACKGROUND OF THE INVENTION

1. Field of the Invention

The present invention relates to a communication terminal device that allows displaying of information such as text data, graphics data or the like, which are obtained via a network, and in particular to a communication terminal device and a content displaying method capable of displaying contents having multimedia information described in various information description languages.

2. Description of the Related Art

With the recent progress of implementation technologies, communication technologies and the like, a personal digital assistant (PDA) or a portable communication terminal device typified by a portable telephone are allowed to access various servers on the Internet in which computer networks are connected to each other. Therefore, the user of a communication terminal device can perform not only e-mail exchange but also browsing information of texts and graphics in contents obtained from various servers on the display of the communication terminal device.

As shown in FIG. 1, a communication terminal device 10 is connected to a content server 12 via a network 11, for example, the Internet. In the content server 12, such contents that are composed of multimedia data in various formats including texts and graphics are stored. The contents are described in HyperText Markup Language (HTML) that is an information description language. With a reserved word which is inserted between “<” and “>” called tag, HTML can describe a document structure and designate the location of a file such as still picture, moving picture, voice or the like and the link destination thereof. Therefore, HTML is used to create a content as browsing information having the HyperText structure allowing, for example, the jump from one part in the displayed text to another part and the display of another text. The content server 12 storing these contents has a unique address assigned thereto on the network 11, and each content stored in the content server 12 can be identified by each individual Uniform Resource Locator (URL).

The communication terminal device 10 such as a portable telephone can be connected to the Internet as the network 11 via a mobile telephone network (not shown.) In this communication terminal device 10, a program for browsing contents, called a browser, is previously installed. The browser is used to connect the communication terminal device 10 to the content server 12 on the network 11 via the mobile telephone network (not shown) and the HTML-described contents specified by URL input from a key pad by the user. Then, in the communication terminal device 10, the content obtained is interpreted by this browser to display it on the display device such as a liquid-crystal display (LCD). In this manner, the user of communication terminal device 10 can browse the displayed content.

The network 11 uses the HyperText Transfer Protocol (HTTP) to allow the content described in HTML to be transferred between the communication terminal device 10 and the content server 12. The HTTP communication is normally carried out on TCP/IP (Transmission Control Protocol/Internet Protocol) connection established between the content server 12 and the communication terminal device 10. More specifically, the communication terminal device 10 as a client transmits a URL specifying the desired content as Request to the content server 12 via this established connection and then the content server 12 transmits the desired content as Response back to the communication terminal device 10. In such a HTTP communication, contents described in various kinds of information description languages including HTML and other types of data formats can be obtained.

The content transferred according to HTTP has a protocol header added to the header thereof and the protocol header includes MIME (Multipurpose Internet Mail Extensions) data, which identifies the content and specifies the encoding method in the MIME format. The communication terminal device 10 refers to this MIME data to identify the type of obtained content.

FIG. 2 schematically shows content transferred in the system as shown in FIG. 1. Content 15 is composed of a protocol header field 16 and a content data field 17. When a content is transmitted via the network 11 according to HTTP, information in the protocol header field 16 is added by one of a plurality of transit servers in this network 11 and includes, for example, MIME data 18 identifying the content type, as well as a method indicating Request, the resource URL to which this method is applied, and its protocol version. The content data field 17 stores HTML data describing the content to be browsed in the communication terminal device 10. In FIG. 2, the MIME data 18 of content 15 indicates that the requested content is a HTML text file and is to be handled as binary data.

FIG. 3 shows a sequence of content obtaining operation of the communication terminal device. When the user of communication terminal device 10 uses the keypad to enter the URL of desired content, the browser transmits a GET request including this URL as a request 20 according to HTTP to the content server 12. In the case of a portable telephone, the request 20 is transmitted to the Internet 11 via the mobile telephone network. When the content server 12 receives the request 20 via the network 11, the designated content is transmitted as a response 21 back to the communication terminal device 10.

As shown in FIG. 2, the response 21 is transmitted in the network 11 while adding a HTTP header as a protocol header thereto at various transit servers. When receiving this response 21, the communication terminal device analyzes MIME data included in the HTTP header corresponding to the protocol header field of the content shown FIG. 2 (analysis 22).

MIME data includes information identifying the type of received content. However, the HTTP header including this MIME data is not added by an origin server supplying the content data, but by a transit server. Therefore, the MIME data does not always reflect the proper type of content. The browser discriminates the type of received content by referring to the content data field of the received content rather than the MIME data (type discrimination 23). For example, when a prescribed pattern is detected from the content data field, it is determined that the content data is of the type corresponding to this prescribed patter. If the type cannot be determined from the received content data, then it is determined by the analytical result of MIME data included in HTTP header. When the received content is a GIF (Graphics Interchange Format) file, it is expanded using a predetermined process. When the received content is a HTML file, the lexical analysis of HTML is performed before the rendering process. After the processing corresponding to the discriminated content type, the content is displayed on the display device such as an LCD of the communication terminal device 10 (display processing 24).

In the case of the communication terminal device 10 being a portable telephone, for the purpose of power saving and miniaturization, the content are described in a compact HTML that is a subset of HTML and in a Wireless Markup Language (thereafter, described as WML) like HTML, where a unit of data to be transferred is “a deck” including a plurality of “cards”, each of which includes a screen of display data. In a wireless application Protocol (WAP) system providing the content described in WML, supplied content data are converted into binary data in units of deck and the binary data are transferred, resulting in improved efficiency of network.

Therefore, in the case where the content data subjected to decoding process corresponding to the encoding defined in MIME data is described in HTML, the communication terminal device lO enables the content to be displayed as text data on the display by the browser.

In the case where the content data subjected to decoding process corresponding to the encoding defined in MIME data is described in WML, the content data is binary data and therefore the content can be displayed on the display after the binary process is performed by the browser.

In recent years, respective mobile telephone companies construct contents service systems using content to provide information as well as e-mail services in unique specifications. The service competition for users heats up, and as a result the contents are reinforced to provide more advanced content services than that of another company.

However, since the respective mobile telephone companies construct their own servers to provide the contents each described in unique information description languages, a large amount of development cost or man-hours are required. Therefore, the content providers preferably share these contents from the viewpoint of efficiency of man-hours. While, the content users preferably browse not only the contents provided by a plurality of mobile telephone companies but also the contents described in HTML on a very large number of content servers connected to the existing Internet.

Further, since such contents are described in a plurality of information description languages having no compatibility with each other, the communication terminal device having a single browser installed therein can display only contents processed by the installed browser. For example, the processing required for browsing in WML is different from that in HTML. Therefore, in order to display contents described in various information description languages, a plurality of browsers corresponding to respective ones of information description languages are needed to be installed in the communication terminal device.

However, if plural browsers for different information description languages are installed to the communication terminal device, then the size of the terminal gets bigger and the cost becomes more expensive. Also, as described above, since the HTTP header, which is included in the content received from the existing network, is not added by an origin server, it cannot insure the reliability of the described content of a HTTP header, particularly of MIME data. Furthermore, when the contents described in other information description language like WML are mixed, it is getting more difficult to assure the accuracy of MIME data.

### SUMMARY OF THE INVENTION

An object of the present invention is to provide a communication terminal device and a content displaying method that can achieve browsing contents described in different information description languages without installing corresponding browsers.

Another object of the present invention is to provide a communication terminal device that can achieve browsing contents described in different information description languages without referring to the MIME data of HTTP header.

According to an aspect of the present invention, a communication terminal device includes: a content obtainer for obtaining content data from a desired content server via a network; a content-type discriminator for discriminating a content type of the obtained content data from a plurality of predetermined content types; a plurality of parsers corresponding to respective ones of the plurality of predetermined content types, wherein the obtained content data is parsed by a corresponding parser depending on the discriminated content type thereof to produce displaying information; and a displaying section for displaying an obtained content based on the displaying information.

The plurality of predetermined content types may be determined by respective ones of information description languages having no compatibility with each other. The information description languages may include HTML (Hyper Text Markup Language) and WML (Wireless Markup Language).

The content-type discriminator may discriminate a content type of the obtained content data by referring to a code arranged at a predetermined location of the obtained content data.

The content-type discriminator may discriminate a content type of the obtained content data by referring to a content-type indicating code included in a protocol header of the obtained content data.

The content-type discriminator may discriminate a content type of the obtained content data by referring to a code arranged at a predetermined location of the obtained content data before referring to a content-type indicating code included in a protocol header of the obtained content data.

According to another aspect of the present invention, a content displaying method in a communication terminal device, includes the steps of: a) obtaining content data from a desired content server via a network; b) discriminating a content type of the obtained content data from a plurality of predetermined content types; c) parsing the obtained content data depending on a discrimination result of the step (b) to produce displaying information; and d) displaying an obtained content based on the displaying information.

The step (b) may include the steps of: b.1) storing a plurality of unique codes each indicating the plurality of predetermined content types; b.2) searching the plurality of unique codes for a code arranged at a predetermined location of the obtained content data to discriminate the content type of the obtained content data; and b.3) when no match is found in the step (b.2), checking a content-type indicating code included in a protocol header of the obtained content data to discriminate the content type of the obtained content data.

The step (b) may include the steps of: b.1) storing a plurality of unique codes each indicating the plurality of predetermined content types; b.2) checking a protocol header of the obtained content data to determine whether the obtained content data is described in a predetermined information description language; and b.3) when it is determined that the obtained content data is not described in the predetermined information description language, searching the plurality of unique codes for a code arranged at a predetermined location of the obtained content data to discriminate the content type of the obtained content data. The step (c) may include the steps of: c.1) when it is determined that the obtained content data is described in the predetermined information description language, parsing the obtained content data based on description of the predetermined information description language to produce the displaying information; and c.2) when it is determined that the obtained content data is not described in the predetermined information description language, parsing the obtained content data based on the discriminated content type of the obtained content data.

The step (b) may include the steps of: b.1) storing a plurality of unique codes each indicating the plurality of predetermined content types; b.2) checking a code arranged at a predetermined location of the obtained content data to determine whether the code is text data; and b.3) when it is determined that the code is not text data, searching the plurality of unique codes for a code arranged at a predetermined location of the obtained content data to discriminate the content type of the obtained content data. The step (c) may include the steps of: c.1) when it is determined that the code is text data, parsing the obtained content data based on description of a predetermined information description language to produce the displaying information; and c.2) when it is determined that the code is not text data, parsing the obtained content data based on the discriminated content type of the obtained content data.

The step (b) may include the steps of: b.1) storing a plurality of file name extensions used in a predetermined communication protocol, each of the file name extensions indicating the plurality of predetermined content types; and b.2) searching the plurality of file name extensions for a file name extension of the obtained content data to discriminate the content type of the obtained content data.

The predetermined information description language may be one of HTML (Hyper Text Markup Language) and compact HTML that is a subset of the HTML.

### BRIEF DESCRIPTION OF THE DRAWINGS

FIG. 1 is a diagram showing a outline of the configuration of a network system including a communication terminal device;

FIG. 2 is a diagram showing an example of a content used in the communication terminal device;

FIG. 3 is a diagram showing a sequence of content obtaining operation in a conventional content display system;

FIG. 4 is a block diagram showing the configuration of a communication terminal device according to the present invention;

FIG. 5 is a flow chart showing an operation of discriminating the type of received content according to a first embodiment of the present invention;

FIG. 6 is a flow chart showing an operation of discriminating the type of received content according to a second embodiment of the present invention;

FIG. 7 is a flow chart showing an operation of discriminating the type of received content according to a third embodiment of the present invention; and

FIG. 8 is a flow chart showing an operation of discriminating the type of received content according to a fourth embodiment of the present invention.

### DESCRIPTION OF THE PREFERRED EMBODIMENTS

### First Embodiment

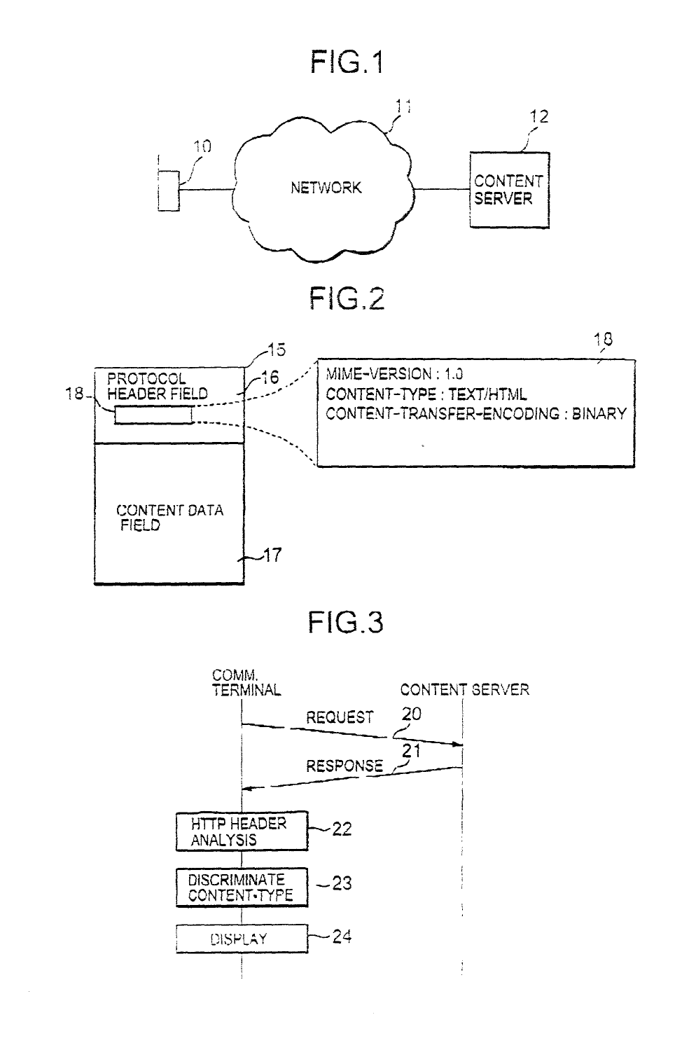

As described before by referring to FIG. 1, a communication terminal device according to the present invention is connected to one of a plurality of content servers via a network such as the Internet. These content servers 12 stores contents described in various information description languages having no compatibility to each other, such as HTML and WML. These content servers have unique individual addresses assigned thereto on the network, and various contents stored in each content server can be identified by each individual URL. In the network, contents described in respective information description languages are transferred according to HTTP between the communication terminal device and each content server. At this time, a HTTP header is added by a transit server in the network. The HTTP header includes MIME data in MIME format, which identifies the type of content and the encoding scheme. Therefore, the MIME data can be used to identify the type of content to be obtained.

The communication terminal device according to the present invention may be a personal computer with wireless communication function, a PDA, or a portable telephone, having browsing software called a browser installed therein. When a user specifies the content URL, the content corresponding to the URL can be obtained from the content server on the network and it is analyzed and displayed on the display device by the browser. In this manner, the user of communication terminal device can browse the contents.

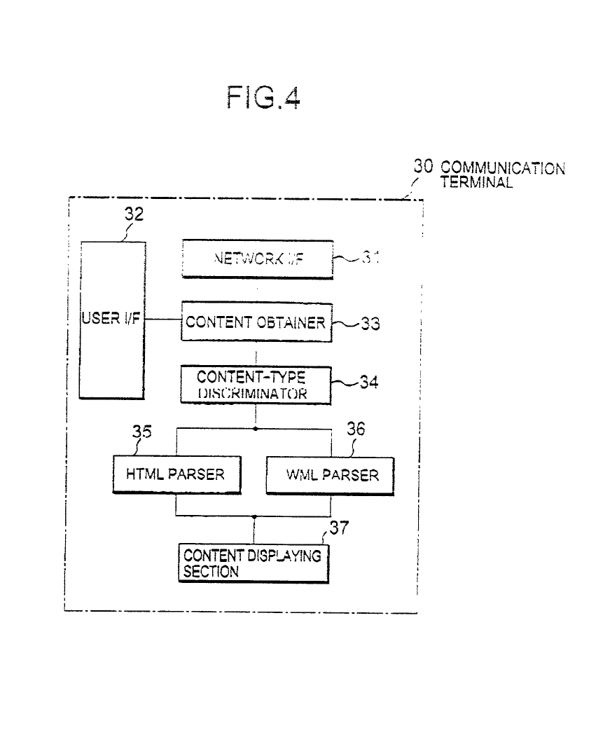

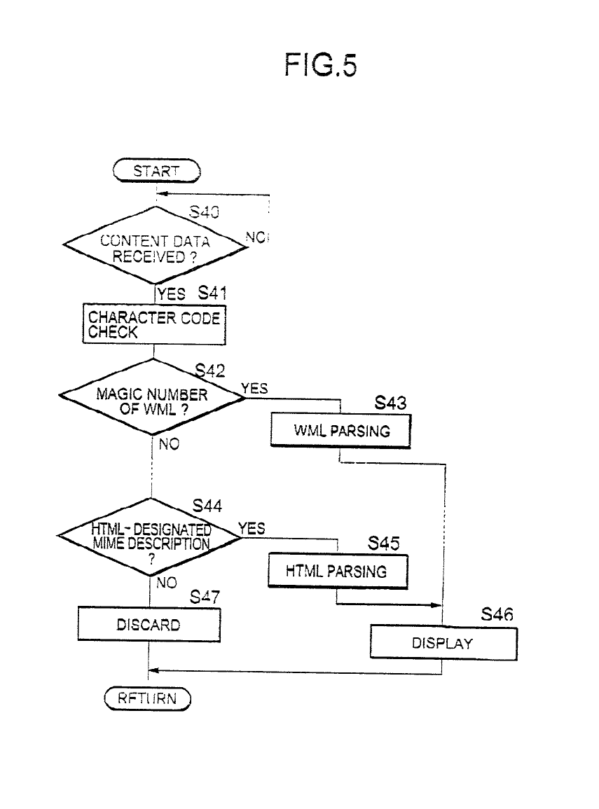

The communication terminal device according to a first embodiment of the present invention can achieve browsing various contents using a single browser. More specifically, it is first determined which one of WML and HTML including a compact HTML is used to describe the content obtained as described before, and then the parser corresponding to the discriminated information description language is activated. The details will be described with reference to FIGS. 4 and 5.

Referring to FIG. 4, a communication terminal device 30 is provided with a network interface 31 to the Internet on which a content servers are accommodated and a user interface 32 allowing a user to enter a content request instruction by designating URL. A content obtainer 33 obtains the requested content from a corresponding content server in the Internet through the network interface 31 in accordance with the content request instruction inputted by the user through the user interface 32.

The communication terminal device 30 is further provided with a content-type discriminator 34 that determines whether the obtained content is described in HTML including the compact HTML or WML. When the content-type discriminator 34 determines that the obtained content is described in HTML or compact HTML, a HTML parser 35 parses tags of HTML-content data as content displaying information and control information. When the content-type discriminator 34 determines that the obtained content is described in WML, a WML parser 36 parses tokens of WML-content data as content displaying information and control information. A content displaying section 37 displays text and graphic information according to the parsed content displaying information and control information.

The network interface 31 establishes the TCP/IP connection to the content server on the Internet, transmits a request including the URL specified by the user, receives the content specified as the response to the request on the TCP/IP connection in accordance with HTTP sequence as shown in FIG. 3.

The user interface 32 receives the URL designated by a user through an input device such as a keyboard in the case of a personal computer or a ten-key pad in the case of a portable telephone. The input URL data is output to the content obtainer 33.

When the content obtainer 33 receives the content request instruction including the URL specified by the user from the user interface 32, the content obtainer 33 instructs the network interface 31 to transmit a content request to a corresponding content server connected with the network. When receiving the content in response to the request from the content server, the received content is transferred to the content-type discriminator 34.

The content-type discriminator 34 looks at the header portion of the content obtained by the content obtainer 33 to determine whether the obtained content is described in HTML (or the compact HTML) or WML. As known well, in the contents other than described in HTML or compact HTML, a predetermined pattern called a magic number is written in the first 4 bytes of the content. For example, in the case of content described in WML, a fixed pattern of “0×00 0×02 0×00 0×07” is arranged in the first 4 bytes of the content. Therefore, by looking at the first 4 bytes of the obtained content, the content-type discriminator 34 can determine whether the content is described in WML or not. When the content-type discriminator 34 determines that the content is described in WML, the obtained content is transmitted to the WML parser 36.

If the content-type discriminator 34 determines that the first four bytes of the content is not the predetermined magic number, then the content-type discriminator 34 checks the MIME data of HTTP header, which is added to the header of obtained content, to determine whether the content is described in HTML (compact HTML). When it is determined that the content is described in HTML or compact HTML, the obtained content is transmitted to the HTML parser 35. Further, a GIF file of graphics data, an EXE file that is an execution file, and the like may be obtained as the content. Since they have the predetermined magic number, respectively, when they are detected, they are transmitted to the HTML parser 35. As in a conventional case, they are processed as GIF file or EXE file included in the content described in HTML or compact HTML.

The HTML parser 35 parses the displaying properties, such as a character size, a character displaying color, a character arrangement, a graphics display and the like from HTML tags described in the obtained content, to analyze display information and operation information, and the analyzed result is output to the content displaying section 37.

The WML parser 36 parses WML token described in the obtained content, and analyzes the displaying properties in units of “card” such as a character size, a character displaying color, a character arrangement, a graphics display and the like, to analyze display information and operation information, and the analyzed result is output to the content displaying section 37.

The content displaying section 37 displays such information as characters, graphics, or the like on the display device in accordance with the analyzed result received from the HTML parser 35 or the WML parser 36.

The communication terminal device 30 is provided with a program-controlled processor such as a central processing unit (CPU) and a read-only memory storing control programs for implementing the above-described functions including the content obtainer 33, content-type discriminator 34, HTML and WML parsers 35 and 36.

Operation

Next, an operation of the communication terminal device 30 will be described.

When the communication terminal device 30 receives a content request including the URL identifying the desired content through the user interface 32, this is transferred to the content obtainer 33. Upon receipt of the content request instruction, the content obtainer 33 instructs the network interface 31 to transmit a content request to a corresponding content server connected to the Internet. After a TCP/IP connection is established between the network interface 31 and the content server, the network interface 31 receives the requested content from the content server in accordance with the HTTP communication protocol and outputs it to the content obtainer 33. When receiving the content in response to the request from the content server, the received content is transferred to the content-type discriminator 34.

In this embodiment, the content-type discriminator 34 is implemented by running a content-type discrimination control program on the CPU. The details of the content-type discrimination will be described with reference to the FIG. 5.

Content-Type Discrimination

Referring to FIG. 5, the content-type discriminator 34 determines whether the content corresponding to URL specified by a user is received or not (step S40). When the requested content has been received (YES at step S40), the content-type discriminator 34 performs a character code check for received content to check the first character code of the received content (step S41).

As a result of the character code check, for example, when a fixed pattern of “0×00 0×02 0×00 0×7F” that is predetermined as the magic number of WML is detected (YES at step S42), the obtained content is output to the WML parser 36. In the WML parser 36, the received content is analyzed in accordance with WML description (step S43). That is, the WML parser 36 parses the WML token described in the received content and analyzes the displaying properties in units of “card” such as a character size, a character displaying color, a character arrangement, a graphics display and the like, to produce display information and operation information, and the analyzed result is output to the content displaying section 37.

When the magic number of WML is not detected (NO at step S42), it is further determined whether the magic number of GIF file or EXE file is detected as in the case of the magic number of WML. When the magic number of GIF file or EXE file is detected from the first characters of the received content, the received content is output to the HTML parser 35. In the HTML parser 35, similarly to the conventional browser, the received content is handled as GIF file or EXE file included in content described in HTML or compact HTML. That is, for example, when a magic number of GIF linked to HTML data is detected, the received content is expanded as a GIF file and the result is output to the content displaying section 37 as displaying information for displaying it at the location specified by HTML data. Similarly, when a magic number of GIF file linked to WML data is detected, the received content is expanded as a GIF file and the result is output to the content displaying section 37 as displaying information for displaying it at the location specified by WML data.

Although GIF file or EXE file is processed in the HTML parser 35 in this case, a dedicated parser can be provided.

In this manner, the magic number check is performed for each data type and, if no magic number is found, then the HTTP header of received content is analyzed. Most of the contents provided on the existing Internet are described in HTML or compact HTML. Therefore, here, on the understanding that the content, which is described in HTML or compact HTML, has a correct HTTP header description added on the way of being transmitted through transit servers, the type of the content described in HTML or compact HTML is determined by referring to the MIME data of HTTP header.

More specifically, the content-type discriminator 34 looks at the MIME data to determined whether the obtained content is designated as HTML data or not (step S44). When the obtained content is designated as HTML data or compact HTML (YES at step S44), the obtained content is output to the HTML parser 35. In the HTML parser 35, the received content is analyzed in accordance with the description in HTML or compact HTML (step S45). For example, HTML tags described in the received content are parsed to analyze the display properties including character size, character displaying color, character arrangement, graphics displaying and the like as displaying information and operation information, and the analyzed result is output to the content displaying section 37.

Text and graphics information are displayed by the content displaying section 37 in accordance with the displaying information and the operation information received from the HTML parser 35 or WML parser 36 (step S46). Then, the receipt of content data is monitored again (Return).

When the obtained content is not designated as HTML data or compact HTML (NO at step S44), the obtained content is discarded (step S47) and, for example, this transaction is terminated in error. Then, the receipt of content data is monitored again (Return).

As described above, the content-type discriminator 34 checks the first bytes of received content. When the magic number of WML is found, the obtained content is analyzed in accordance with the WML description at the WML parser 36. When the magic numbers corresponding to respective ones of other data types such as GIF are found, the predetermined displaying information are generated for respective types. Finally, when no magic number is found, MIME data described at the HTTP header of obtained content is checked and if the content is described in HTML or compact HTML, then it is output to the HTML parser 35, which analyzes it in accordance with the description in HTML or compact HTML. The respective contents described in different information description languages having no compatibility to each other are analyzed by corresponding parsers and thereby these contents can be displayed in the content displaying section 37.

Therefore, the communication terminal device 30 does not need the installation of browsers corresponding to respective ones of information description languages. For example, the content described in HTML or compact HTML and the other content described in WML can be both browsed. Since all kinds of contents described in HTML, compact HTML and WML can be browsed, the user can obtain greatly informative content services. Also, the content providers can reduce the development man-hours, because they do not need to prepare for the substantially same contents for each information description language. Therefore, they can provide the more enriched contents.

### Second Embodiment

A communication terminal device according to a second embodiment checks MIME data of HTTP header before determining whether the obtained content is described in HTML (compact HTML). Thereafter, the predetermined magic numbers for respective ones of data types such as WML or the like are discriminated.

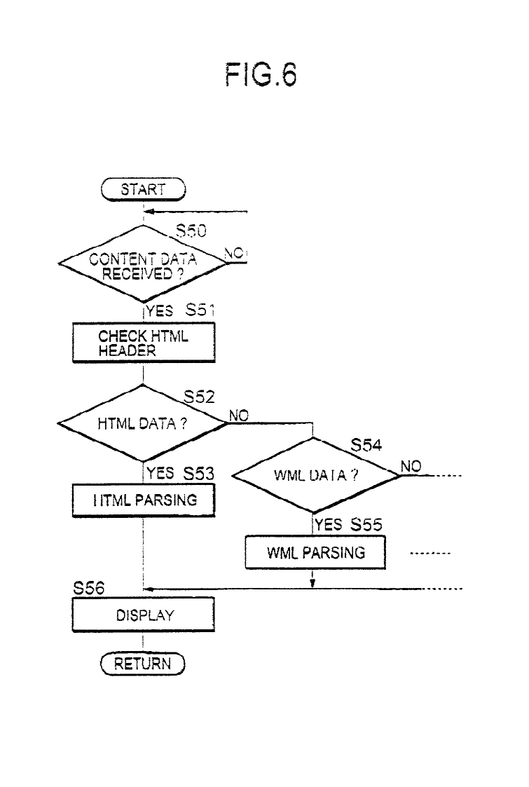

Since the configuration of the communication terminal device according to the second embodiment is the same as that of the first embodiment as shown in FIG. 4, the details thereof are omitted. However, the content-type discrimination of the second embodiment is different from that of the first embodiment. The details of content-type discrimination of the second embodiment will be described with reference to FIG. 6.

Referring to FIG. 6, the content-type discriminator 34 determines whether the content corresponding to URL specified by a user is received or not (step S50). When the requested content has been received (YES at step S50), the content-type discriminator 34 checks the HTTP header added to the received content (step S51).

When it is determined from MIME data in the HTTP header that the obtained content is designated as HTML data (YES at step S52), this is output to the HTML parser. In the HTML parser, the received content is analyzed in accordance with the description in HTML or compact HTML (step S53), and the analytical result is output to the content displaying section.

On the other hand, at step S52, when it is determined from MIME data in the HTTP header that the obtained content is not designated as HTML data (NO at step S52), a character code check of the received content is performed (step S54.)

As a result of the character code check, for example, when a fixed pattern of “0×00 0×02 0×00 0×7F” that is predetermined as the magic number of WML is detected (YES at step S54), the obtained content is output to the WML parser. In the WML parser, the received content is analyzed in accordance with WML description (step S55). The analyzed result is output to the content displaying section.

When the magic number of WML is not detected (NO at step S54), it is further determined whether the magic number of GIF file or EXE file is detected as in the case of the magic number of WML. When the magic number of GIF file or EXE file is detected from the first characters of the received content, the received content is output to the HTML parser. For example, when a magic number of GIF linked to HTML data is detected, the received content is expanded as a GIF file and the result is output to the content displaying section 37 as displaying information for displaying it at the location specified by HTML data.

In this manner, the magic number check is performed for each data type and, if no magic number is found, then the obtained content is discarded and, for example, this transaction is terminated in error. Thereafter, the receipt of content data is monitored again (Return).

Thus, when the content displaying section receives the result analyzed in each parser, and information of texts and graphics or the like are displayed in accordance with the displaying information or the operation information (step S56). Then, the receipt of content data is monitored again (Return).

As described above, the communication terminal device according to the second embodiment checks the MIME data of HTTP header added to the received content, and determines whether the content is described in HTML or not. When the content is not described in HTML or compact HTML, the predetermined magic number for each data type is detected to perform a corresponding parsing process. Therefore, the content described in each information description language can be browsed without installing browsers for respective ones of different information description languages having no compatibility to each other.

### Third Embodiment

In the first and second embodiments as described above, when the received content is described in HTML or compact HTML, it is assumed that the MIME data described at HTTP header is substantially accurate. A third embodiment of the present invention does not have such an assumption. In the communication terminal device according the third embodiment, an information description language is discriminated only by checking the text code check in order to reduce the processing load of communication terminal device, even if the accuracy of MIME data described at HTTP header is relatively low.

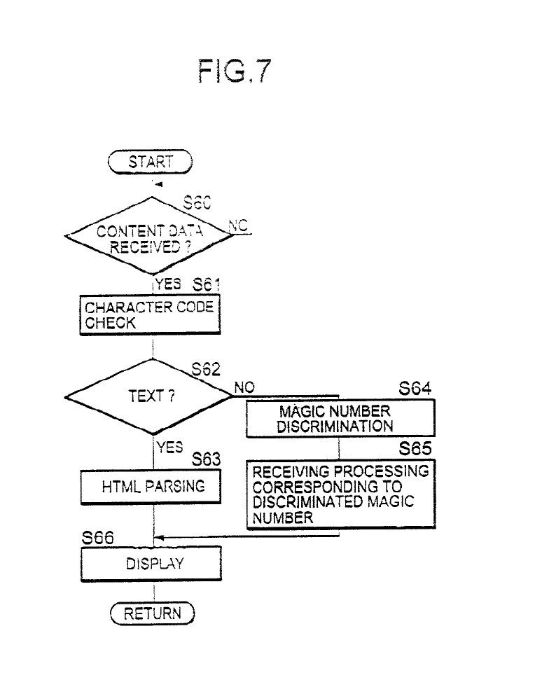

Since the configuration of the communication terminal device according to the second embodiment is the same as that of the first embodiment as shown in FIG. 4, the details thereof are omitted. However, the content-type discrimination of the third embodiment is different from that of the first embodiment. The details of content-type discrimination of the second embodiment will be described with reference to FIG. 7.

Referring to FIG. 7, the content-type discriminator determines whether the content corresponding to URL specified by a user is received or not (step S60). When the requested content has been received (YES at step S60), the content-type discriminator the first one or more bytes of received contents (step S61).

As a result, when it is determined that the first one or more bytes of received content is text data (YES at step S62), the received content is output to the HTML parser. In the HTML parser, the received content is analyzed in accordance with the description in HTML or compact HTML (step S63), and then the analytical result is output to the content displaying section.

On the other hand, at the step S62, when it is determined that the first one or more bytes of received content is not text data (NO at step S62), the magic number discrimination is performed with respect to respective ones of predetermined magic numbers (step S64). In the case where a match is found, the content is output to a corresponding parser, and the displaying information and operation information are generated to display it on the content displaying section (step S65).

Thus, in the content displaying section which receives the analytical result from each parser, information of texts and graphics or the like are displayed in accordance with the displaying information or the operation information received as a analytical result (step S66). Then, the receipt of content data is monitored again (Return).

In the communication terminal device according to the third embodiment, after the first one or more bytes of obtained content are used to determine whether the obtained data is of text or binary, the received content is determined, for example, in HTML (compact HTML) or WML. Therefore, in the case where the accuracy of MIME data described at HTTP header is not high, the information description language in which the obtained content is described can be discriminated without referring to the MIME data, resulting in reduced processing load of communication terminal device.

### Fourth Embodiment

In the first to third embodiments, the information description language describing the content is discriminated by referring to the received content data. A communication terminal device according to a fourth embodiment does not have such a restriction. In the fourth embodiment, when a content request is performed for obtaining desired content from the content server in accordance with HTTP, the URL extension attached to the request from HTTP is used to determine the type of content data.

In general, when the content specified by a URL is described in HTML, the extension of a content data file is “.html”, and when the content is described in WML,, the extension of content data file is “.wml”. Therefore, by registering a plurality of extensions in advance, it is possible to discriminate the information description language and execute the parsing process corresponding to a file extension of URL, and thereby contents described in various information description languages can be displayed.

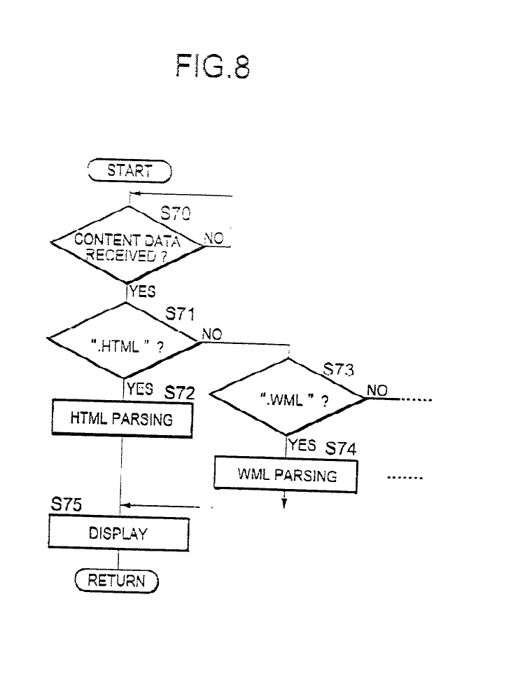

Since the configuration of the communication terminal device according to the fourth embodiment is the same as that of the first embodiment as shown in FIG. 4, the details thereof are omitted. However, the content-type discrimination of the third embodiment is different from that of the first embodiment. The details of content-type discrimination of the second embodiment will be described with reference to FIG. 8.

Referring to FIG. 8, the content-type discriminator determines whether the content corresponding to URL specified by a user is received or not (step S70). When the requested content has been received (YES at step S70), the content-type discriminator discriminates the file extension of content data showing the description language of the received content specified by an URL added as a GET request of HTTP by a user.

More specifically, when the file extension is “.html” for the content data (YES at step S71), the received content is regarded as described in HTML or compact HTML, and this content is output to the HTML parser. In the HTML parser, after the received content is analyzed in accordance with the description of HTML or compact HTML, the analytical result is output to the content displaying section.

On the other hand, at the step S71, when the file extension is not “.html” but “.wml” for the content data (NO at step S71, YES at step S73), the received content is regarded as described in WML, and this is output to the WML parser. In the WML parser, after the received content is analyzed in accordance with the description of WML, the analytical result is output to the content displaying section.

At the step S73, when a file extension is not “.wml” but other file extension for the content data (NO at step S73), searching is performed for a match with one of the predetermined file extensions and, if a match is found, a corresponding parsing process is performed.

In this manner, information of texts and graphics or the like are displayed by the content displaying section in accordance with the display information or the operation information received as an analytical result from the corresponding parser, (step S75). Then, the receipt of content data is monitored again (Return).

As described above, according to the fourth embodiment, since the file extension of content data is discriminated, it can be determined whether the received content is described in, for example, HTML (compact HTML) or WML. Therefore, when the accuracy of MIME data described at HTTP header is not high, the contents described in various information description languages can be browsed without checking the MIME data, and thereby the processing load of communication terminal device can be reduced.

Although, in the first to fourth embodiments, the description language is HTML, compact HTML or WML, some contents may be described in other description languages except these ones.

According to the present invention as descried above, the communication terminal device does not need the installation of browsers for respective ones of information description languages having no compatibility to each other to display the contents described in various information description languages. Therefore, the users can obtain the greatly informative content services. Also, the content providers can reduce the development man-hours, because they do not need to prepare for the substantially same contents for respective ones of information description languages. Therefore, the content providers can provide the more enriched contents.

Further, in the case where the protocol header specifies the content type accurately, the information description language can be discriminated more accurately to display a corresponding content.

On the other hand, in the case where the accuracy of protocol header is not high, information description languages in which, the obtained contents are described can be discriminated without referring to the protocol header, resulting in reduced processing load of communication terminal device.

As described before, a large number of contents described in various information description languages on the existing Internet can be browsed.

1. A communication terminal device comprising:
a content obtainer for obtaining content data from a desired content server via a network;
a content-type discriminator for discriminating a content type of the obtained content data from a plurality of predetermined content types;
a plurality of parsers corresponding to respective ones of the plurality of predetermined content types, wherein the obtained content data is parsed by a corresponding parser depending on the discriminated content type thereof to produce displaying information; and
a displaying section for displaying an obtained content based on the displaying information.

2. The communication terminal device according to claim 1, wherein the plurality of predetermined content types are determined by respective ones of information description languages having no compatibility with each other.

3. The communication terminal device according to claim 2, wherein the information description languages include HTML (Hyper Text Markup Language) and WML (Wireless Markup Language).

4. The communication terminal device according to claim 1, wherein the content-type discriminator discriminates a content type of the obtained content data by referring to a code arranged at a predetermined location of the obtained content data.

5. The communication terminal device according to claim 1, wherein the content-type discriminator discriminates a content type of the obtained content data by referring to a content-type indicating code included in a protocol header of the obtained content data.

6. The communication terminal device according to claim 1, wherein the content-type discriminator discriminates a content type of the obtained content data by referring to a code arranged at a predetermined location of the obtained content data before referring to a content-type indicating code included in a protocol header of the obtained content data.

7. A content displaying method in a communication terminal device, comprising the steps of:
a) obtaining content data from a desired content server via a network;
b) discriminating a content type of the obtained content data from a plurality of predetermined content types;
c) parsing the obtained content data depending on a discrimination result of the step (b) to produce displaying information: and
d) displaying an obtained content based on the displaying information.

8. The content displaying method according to claim 7. wherein the stop (b) comprises the steps of;
b.1) storing a plurality of unique codes each indicating the plurality of predetermined content types;
b.2) searching the plurality of unique codes for a code arranged at a predetermined location of the obtained content data to discriminate the content type of the obtained content data; and
b.3) when no match is found in the step (b.2), header of the obtained content data to discriminate the content type of the obtained content data.

9. The content displaying method according to claim 7, wherein the step (b) comprises the steps of:
b.1) storing a plurality of unique codes each indicating the plurality of predetermined content types;
b.2) checking a protocol header of the obtained content data to determine whether the obtained content data is described in a predetermined information description language; and
b.3) when It is determined that the obtained content data is not described in the predetermined information description language, searching the plurality of unique codes for a code arranged at a predetermined location of the obtained content data to discriminate the content type of the obtained content data, and
The Step (c) Comprises The Steps Of:
c.1) when it is determined that the obtained content data is described in the predetermined information description language, parsing the obtained content data based on description or the predetermined information description language to produce the displaying information; and
c.2) when it is determined that the obtained content data is not described in the predetermined information description language, parsing the obtained content data based on the discriminated content type of the obtained content data.

10. The content displaying method according to claim 7, wherein the step (b) comprises the steps of:
b.1) storing a plurality of unique codes each indicating the plurality of predetermined content types,
b.2) checking a code arranged at a predetermined location or the obtained content data to determine whether the code is text data; and
b.3) when it is determined that the code is not text data, searching the plurality of unique codes for a code arranged at a predetermined location of the obtained content data to discriminate the content type of the obtained content data, and
The Step (c) Comprises The Steps Of;
c.1) when it is determined that the code is text data. parsing the obtained content data based on description of a displaying information: and
c.2) when it is determined that the code is not text data, parsing the obtained content data based on the discriminated content type of the obtained content data.

11. The content displaying method according to claim 7, wherein the step (b) comprises the steps of:
b.1) storing a plurality of file name extensions used in a predetermined communication protocol, each of the file name extensions indicating the plurality of predetermined content types; and
b.2) searching the plurality of file name extensions for a file name extension of the obtained content data to discriminate the content type of the obtained content data.

12. The content displaying method according to claim 9, wherein the predetermined information description language is one of HTML (Hyper Text Markup Language) and compact HTML that is a subset of the HTML.

13. The content displaying method according to claim 10, wherein the predetermined information description language is one Of HTML (Hyper Text Markup Language) and compact HTML that is a subset of the HTML.
